(19) United States
(12) Patent Application Publication
(10) Pub. No.: US 2017/0109689 A1
(43) Pub. Date: Apr. 20, 2017

(54) PRODUCT INVENTORY TRACKING DEVICE, SYSTEM, AND METHOD

(71) Applicants: Christopher S. Lorkowski, Apex, NC (US); William R. Dages, Stow, OH (US); Mark Lorkowski, Tallmadge, OH (US); Michael Mitchell, Olmsted Falls, OH (US); Michael Perrine, Akron, OH (US)

(72) Inventors: Christopher S. Lorkowski, Apex, NC (US); William R. Dages, Stow, OH (US); Mark Lorkowski, Tallmadge, OH (US); Michael Mitchell, Olmsted Falls, OH (US); Michael Perrine, Akron, OH (US)

(21) Appl. No.: 15/295,975

(22) Filed: Oct. 17, 2016

Related U.S. Application Data
(60) Provisional application No. 62/242,255, filed on Oct. 15, 2015.

(51) Int. Cl. G06Q 10/08; H04W 52/02

(52) U.S. Cl. CPC G06Q 10/087; H04W 52/028; H04W 52/0254

(57) ABSTRACT

A device, system, and method for tracking product inventory may include at least one sensor and at least one wireless communication device. The wireless communication may remain in a standby state until the sensor senses a particular condition, at which time the sensor may instruct the wireless device to transition to an operating state, transmit the sensed condition, and return to the standby state.

### CROSS-REFERENCE TO RELATED APPLICATIONS

This application claims priority from U.S. Provisional Patent Application No. 62/242,255, filed on Oct. 15, 2015, which is incorporated by reference herein in its entirety.

### BACKGROUND

The tracking of inventory in a business can be quite tedious, often resulting in an inventory manager spending a significant amount of time on a regular basis to record the level, age, expiration, etc. of products. As an example, where a restaurant or bar serves draft beer from a keg, a manager must track the age of the beer in any given keg and the amount of beer left in any given keg, and must order additional beer in anticipation of any given keg running dry, so as to not interrupt that restaurant or bar's sale of that beer. Managers may perform this task in complicated or tedious manners, often physically lifting kegs in a crowded walk-in cooler, and simply guessing how much is left, while noting the date that the keg arrived on location.

Additionally, inventory managers often desire to forecast the demand for a particular product to ensure that the product is on hand when needed. Where the product is perishable and storage space is limited, this forecast must be accurate. Again, taking the example of a restaurant or bar that serves draft beer, a manager must estimate the demand of any given beer among the patrons of that restaurant or bar. With the boom in the opening of microbreweries, managers are faced with a larger number of selections than ever. Where a restaurant or bar desires to provide a wide variety of relatively unknown, or new, microbrewery products to patrons, managers are left guessing which offerings may be most desirable to patrons of that facility, and in what part of the year those offerings will be desirable.

Finally, inventory managers may find the job of tracking inventory even more difficult where theft or waste is an issue. Again, taking the example of a restaurant or bar that serves draft beer, bartenders may inadvertently, and largely unknowingly, waste product as a result of accidental spillage or poor pouring. Worse, bartenders may take product for themselves or provide it to acquaintances without entering the dispensing of these products into the sales system. When one considers that a half barrel/full keg of beer is around 16 U.S. gallons (60.6 liters), one realizes that there are only about 128 one pint (0.5 liters) servings of beer in a keg. The waste of, or failure to log, 13 pint servings of product from a keg results in a 10% error in tracking remaining keg product via sales recordings.

What is needed is a cost-effective way of tracking product inventory that is accurate, efficient, and easy to implement. What is needed is a cost-effective way of analyzing dispensing of product, and/or trends related thereto, that is accurate, efficient, and easy to implement.

### SUMMARY

A device for tracking product inventory, comprising: a housing; at least one sensor operatively connected to the housing; at least one wireless communication device having a standby state and an operating state and operatively connected to each of the housing and the sensor; a memory operatively connected to each of the sensor and the wireless communication device; and a power source operatively connected to each of the sensor, the wireless communication device, and the memory; and wherein upon sensing a condition external to the housing: the sensor records the sensed condition in the memory and sends a command to the wireless communication device to transmit the recorded sensed condition; and the wireless communication device, upon receiving the command, transitions from the standby state to the operating state, transmits the sensed condition, and transitions back to the standby state.

A system for tracking product inventory, comprising: a tracking device comprising: a housing; at least one sensor operatively connected to the housing; at least one wireless communication device having a standby state and an operating state and operatively connected to each of the housing and the sensor; a memory operatively connected to each of the sensor and the wireless communication device; and a power source operatively connected to each of the sensor, the wireless communication device, and the memory; and wherein upon sensing a condition external to the housing: the sensor records the sensed condition in the memory and sends a command to the wireless communication device to transmit the recorded sensed condition; and the wireless communication device, upon receiving the command, transitions from the standby state to the operating state, transmits the sensed condition, and transitions back to the standby state; and a remote device comprising: a receiver configured to receive the sensed condition, a memory configured to store the sensed condition, a display configured to display the sensed condition, a graphical user interface configured to permit a user to control at least one of: the tracking device and the remote device, and an input device configured to allow the user to control the graphical user interface.

A method for tracking product inventory, comprising: providing a tracking device operatively connected to at least one of a product storage and a delivery system, wherein the tracking device comprises: a housing; at least one sensor operatively connected to the housing; at least one wireless communication device having a standby state and an operating state and operatively connected to each of the housing and the sensor; a memory operatively connected to each of the sensor and the wireless communication device; and a power source operatively connected to each of the sensor, the wireless communication device, and the memory; and wherein upon sensing a condition external to the housing: the sensor records the sensed condition in the memory and sends a command to the wireless communication device to transmit the recorded sensed condition; and the wireless communication device, upon receiving the command, transitions from the standby state to the operating state, transmits the sensed condition, and transitions back to the standby state; providing a remote device comprising: a receiver configured to receive the sensed condition, a memory configured to store the sensed condition, a display configured to display the sensed condition, a graphical user interface configured to permit a user to control at least one of: the tracking device and the remote device, and providing an input device configured to allow the user to control the graphical user interface; and wherein the method comprises: using the tracking device to: sense a condition of at least one of: a product inventory level, a product inventory delivery system consumption, and a product dispensing quantity, record the sensed condition to the tracking device memory, and transmit the sensed condition with the wireless communication device; and using the remote device to: receive the sensed condition from the tracking device, and record the sensed condition to the remote device memory.

### BRIEF DESCRIPTION OF THE DRAWINGS

The accompanying figures, which are incorporated in and constitute a part of the specification, illustrate various example embodiments, and are used merely to illustrate various example embodiments. In the figures, like elements bear like reference numerals.

FIG. 1A illustrates a perspective view of a device for tracking product inventory installed on a dispensing valve in a first state.

FIG. 1B illustrates an elevational view of a device for tracking product inventory installed on a dispensing valve in a second state.

FIG. 2 illustrates a cutaway view of a tracking device for tracking product inventory.

FIG. 3 illustrates a perspective view of a device 302 for tracking product inventory.

FIG. 4 illustrates a perspective view of device 302 for tracking product inventory installed on a dispensing valve in a first state.

FIG. 5 illustrates a perspective view of a device for tracking product inventory.

FIG. 6 illustrates an internal plan view of a device for tracking product inventory.

FIG. 7 illustrates an internal plan view of a remote device for a system for tracking product inventory.

FIG. 8 illustrates a sample display of product information.

FIG. 9 illustrates a method for using a tracking device.

### DETAILED DESCRIPTION

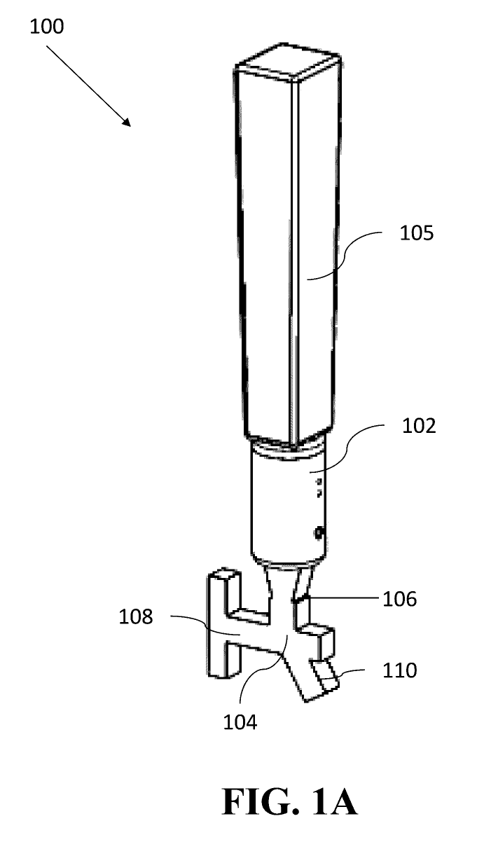

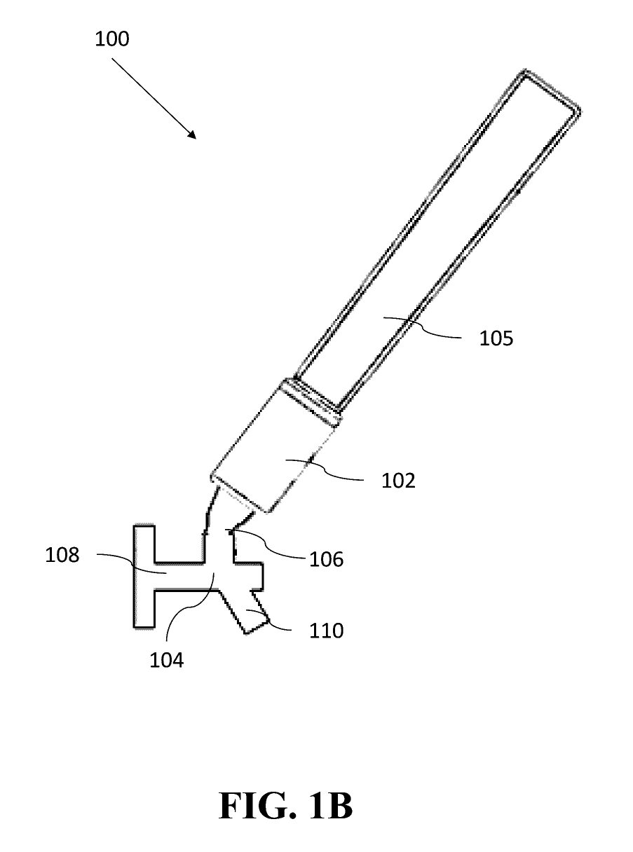

FIGS. 1A and 1B illustrate a perspective view of a device for tracking product inventory installed on a dispensing valve in a first state and a second state, respectively.

A product tracking assembly 100 may include a tracking device 102. Product tracking assembly 100 may be, for example, a beer tap apparatus. Assembly 100 may include a dispenser body 104 connected to a valve 106. Dispenser body 104 may include a fluid input 108 and a fluid output 110. Valve 106 may be configured to allow the selective passage of a pressurized fluid from fluid input 108 to fluid output 110, which permits the fluid to be dispensed into a container, such as a glass. Actuation of valve 106 may be achieved via a user's manipulation of a handle 105. Alternatively, actuation of valve 106 may be achieved through any of a variety of means by which valves are commonly actuated.

In one embodiment, tracking device 102 is operatively connected to at least one of valve 106 and handle 105. As illustrated in FIG. 1A, handle 105 and tracking device 102 may be in a first state, where valve 106 is closed and no fluid is dispensed. As illustrated in FIG. 1B, handle 105 and tracking device 102 may be in a second state, where valve 106 is opened and fluid is dispensed.

As described below, tracking device 102 may be configured to sense at least one of the first state and the second state, and may track the volume of fluid dispensed via any of a variety of means, including a timer where the fluid flow rate is known.

Dispenser body 104, valve 106, handle 105, fluid input 108, and fluid output 110 may collectively make up a product delivery system.

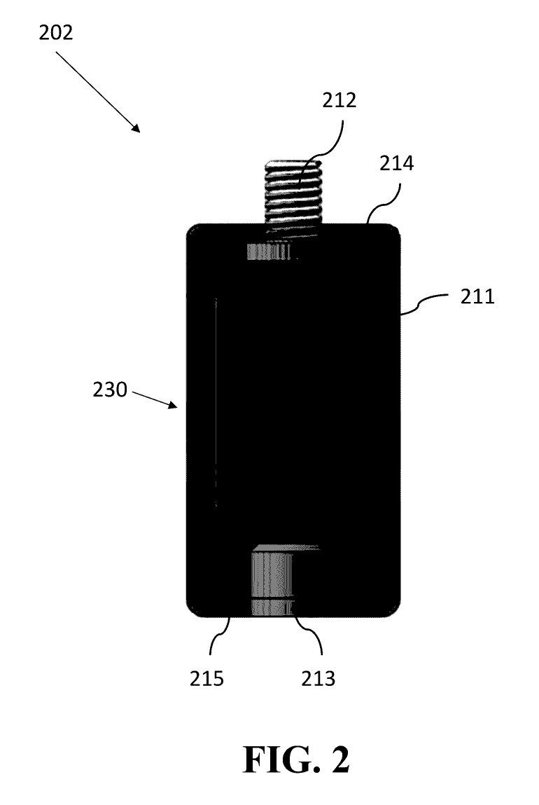

FIG. 2 illustrates a cutaway view of a tracking device 202 for tracking product inventory. Tracking device 202 may include a housing 211. Housing 211 may include a first fastening element 212 oriented on a first surface 214 of housing 211. Housing 211 may include a second fastening element 213 oriented on a second surface 215 of housing 211.

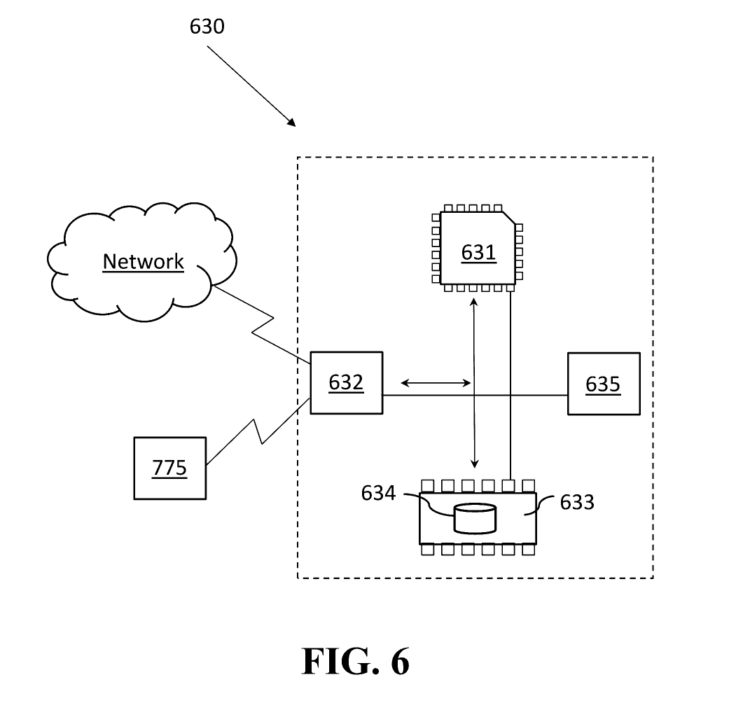

Housing 211 may house at least one set of device components 230 as further described below with respect to FIG. 6.

Housing 211 may be constructed from a heat conductive metal or alloy (e.g., aluminum). Housing 211 may use such a heat conductive material so as to allow device components 230 to measure the temperature of ambient air, fluid to be/being dispensed, or both, at or near the location of tracking device 202. Housing 211 may be constructed from any material, including for example a polymer, a metal, or an alloy.

Housing 211 may be operatively connected to at least one of a product inventory storage system and a delivery system via fastening element 212, 213, wherein fastening element 212, 213 is at least one of an adhesive, a clamp, a hook and loop fastener, a threaded screw, a threaded recess, a snap fitting, a magnet, a hook, a ring, a string, a wire, and a rope.

As illustrated, first fastening element 212 may be a threaded screw extending from housing 211 on first surface 214. Second fastening element 213 may be a threaded recess (female threads) extending into housing 211 on second surface 215. In one embodiment, a tap handle such as handle 105 described with reference to FIGS. 1A and 1B may include a threaded recess configured to screw onto a threaded screw extending from valve 106. Tracking device 202 may mate via second fastening element 213 to a threaded screw extending from valve 106. Handle 105 may mate via a threaded recess to first fastening element 212.

In an alternative embodiment, tracking device 202 may be integrally connected with handle 105, for example, at the time of making handle 105. Tracking device 202 may be included within handle 105.

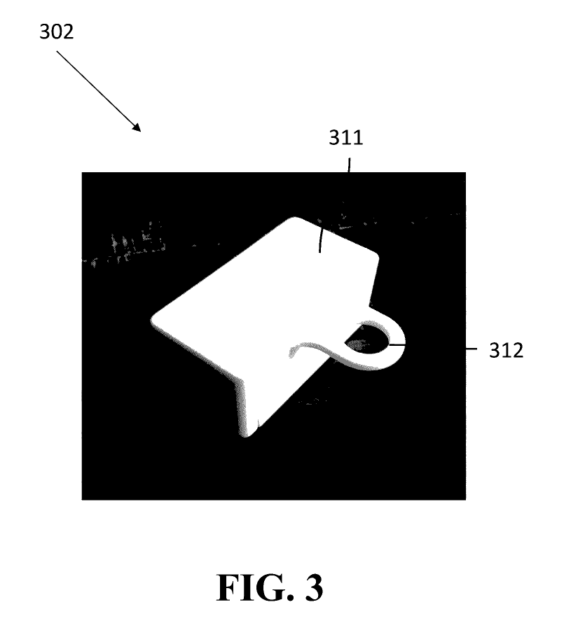

FIG. 3 illustrates a perspective view of a tracking device 302 for tracking product inventory. Tracking device 302 may include a housing 311 and at least one fastening element 312. Housing 311 may be operatively connected to at least one of a product inventory storage system and a delivery system by at least one fastening element 312, wherein at least one fastening element 312 is at least one of an adhesive, a clamp, a hook and loop fastener, a threaded screw, a threaded recess, a snap fitting, a magnet, a hook, a ring, a string, a wire, and a rope.

As illustrated, fastening element 312 may be a loop configured to extend about a portion of a tap handle, such as handle 105 described in FIGS. 1A and 1B. In one embodiment, a user may remove handle 105 from valve 106, insert a portion of handle 105 into fastening element 312, and reattach handle 105 to the threaded stud of valve 106.

Housing 311 may house at least one set of device components 630 as further described below with respect to FIG. 6.

Housing 311 may be constructed from a heat conductive metal or alloy (e.g., aluminum). Housing 311 may use such a heat conductive material so as to allow device components 630 to measure the temperature of ambient air, fluid to be/being dispensed, or both, at or near the location of tracking device 302. Housing 311 may be constructed from any material, including for example a polymer, a metal, or an alloy.

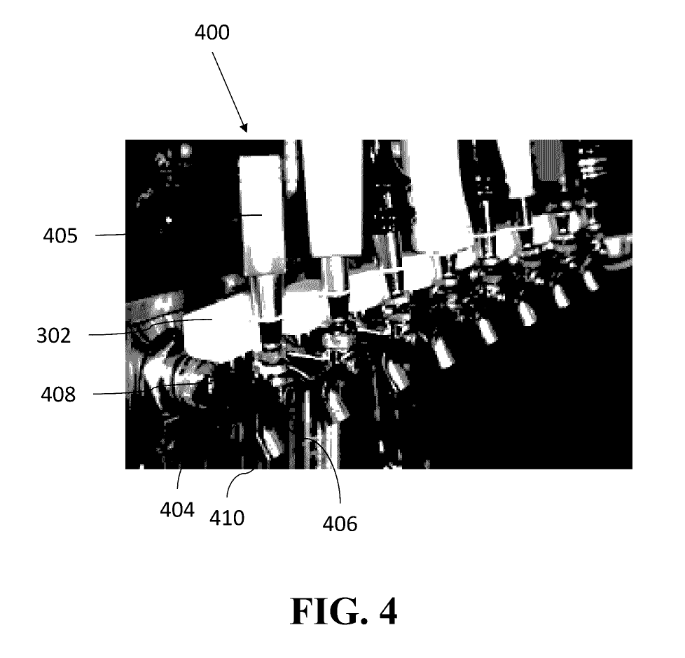

FIG. 4 illustrates a perspective view of tracking device 302 for tracking product inventory installed on a dispensing valve in a first state.

A product tracking assembly 400 may include tracking device 302. Product tracking assembly 400 may be, for example, a beer tap apparatus. Assembly 400 may include a dispenser body 404 connected to a valve 406. Dispenser body 404 may include a fluid input 408 and a fluid output 410. Valve 406 may be configured to allow the selective passage of a pressurized fluid from fluid input 408 to fluid output 410, which permits the fluid to be dispensed into a container, such as a glass. Actuation of valve 406 may be achieved via a user's manipulation of a handle 405. Alternatively, actuation of valve 406 may be achieved through any of a variety of means by which valves are commonly actuated.

As illustrated, a portion of handle 405 is oriented through fastening element 312 of tracking device 302.

Dispenser body 404, valve 406, handle 405, fluid input 408, and fluid output 410 may collectively make up a product delivery system.

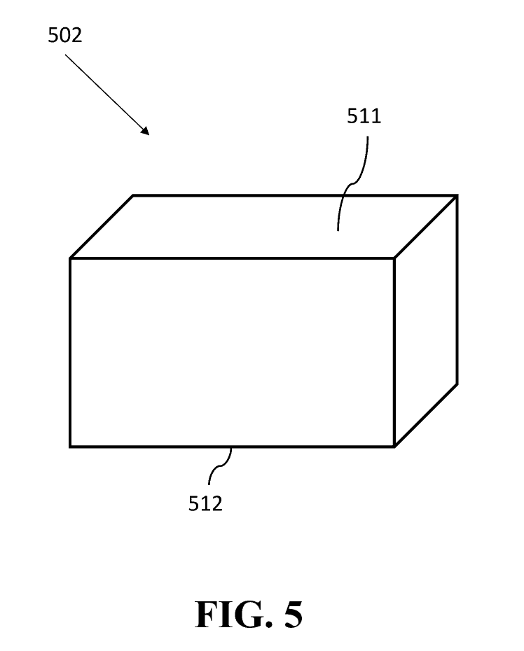

FIG. 5 illustrates a perspective view of a tracking device 502 for tracking product inventory. Tracking device 502 may include a housing 511 and at least one fastening element 512. Housing 511 may be operatively connected to at least one of a product inventory storage system and a delivery system by at least one fastening element 512, wherein at least one fastening element 512 is at least one of an adhesive, a clamp, a hook and loop fastener, a threaded screw, a threaded recess, a snap fitting, a magnet, a hook, a ring, a string, a wire, and a rope.

Housing 511 may house at least one set of device components 630 as further described below with respect to FIG. 6.

Housing 511 may be constructed from a heat conductive metal or alloy (e.g., aluminum). Housing 511 may use such a heat conductive material so as to allow device components 630 to measure the temperature of ambient air, fluid to be/being dispensed, or both, at or near the location of tracking device 502. Housing 511 may be constructed from any material, including for example a polymer, a metal, or an alloy.

FIG. 6 illustrates an internal plan view of a device for tracking product inventory. Any of the aforementioned tracking devices may include device components 630, which may include at least one sensor 631 operatively connected to a wireless communication device 632. Sensor 631 may also be operatively connected to a memory 633. Device components 630 may include at least one database 634 communicatively coupled to at least one of: sensor 631 and memory 633.

A power source 635 may be operatively connected to one or more of sensor 631, wireless communication device 632, and memory 633. Power source 635 may include an electric battery. Power source 635 may be configured to provide electric power of one or more of sensor 631, wireless communication device 632, and memory 633.

Sensor 631 may be operatively connected to tracking device housing 211, 311, 511.

Wireless communication device 632 may have a standby state and an operating state. Wireless communication device 632 may be operatively connected to tracking device housing 211, 311, 511. Wireless communication device 632 may be operatively connected to sensor 631.

Memory 633 may be operatively connected to one or more of sensor 631 and wireless communication device 632. Memory 633 may include a nonvolatile semiconductor memory.

Upon sensor 631 sensing a trigger condition external to housing 211, 311, 511, sensor 631 may record the sensed condition in memory 633. Upon sensor 631 sensing a trigger condition external to housing 211, 311, 511, sensor 631 may send a command to wireless communication device 632 to transmit the recorded sensed condition. Wireless communication device 632 may, upon receiving the command from sensor 631, transition from a standby state to an operating state, transmit the sensed condition, and transition back to the standby state. The standby state may consume a sufficient quantity of power from power source 635 for wireless communication device to receive and interpret the command from sensor 631, but may consume an insufficient quantity of power from power source 635 than is needed for wireless communication device 632 to communicate wirelessly. The operating state may consume a sufficient quantity of power from power source 635 for wireless communication device 632 to communicate wirelessly.

In one embodiment, sensor 631 is always “on” and drawing power from power source 635. Sensor 631 is “on” during the standby state of wireless communication device 632. Sensor 631 may draw less power than wireless communication device 632 in wireless communication device 632's operating state. In this manner, power in power source 635 may be conserved, thus increasing the life of power source 635.

Wireless communication device 632 may communicate by at least one radio frequency. Wireless communication device 632 may communicate via any known wireless communication method. Wireless communication device 632 may include at least one of: a transmitter, a receiver, a transceiver, and an antenna.

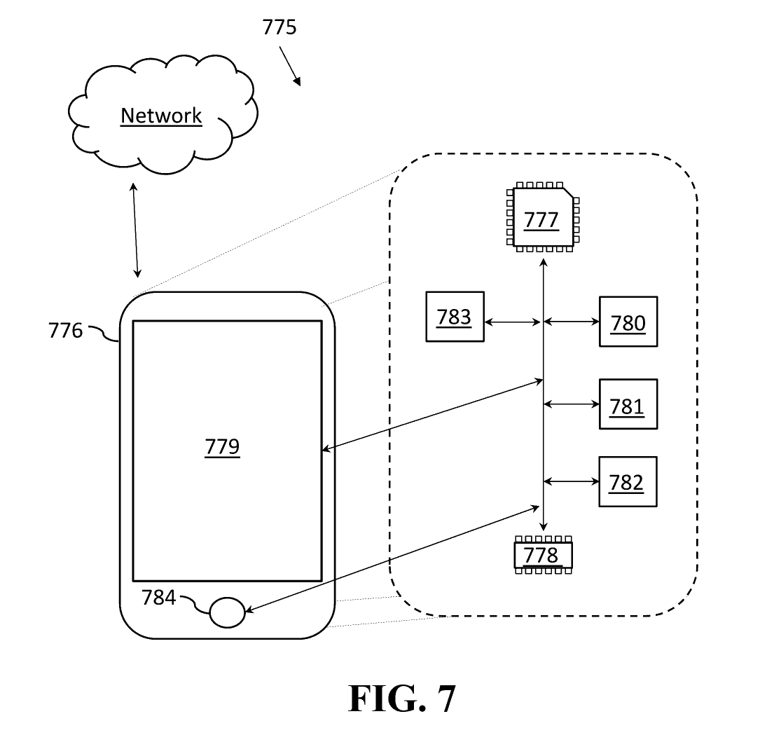

Wireless communication device 632 may transmit the recorded sensed condition to a network. Wireless communication device 632 may transmit the recorded sensed condition to a remote device 775 (described below with reference to FIG. 7). Wireless communication device 632 may transmit the recorded sensed condition to a network and a remote device 775. The network may be a wireless network. Wireless communication device 632 may transmit the recorded sensed condition remote device 775 via a network intermediary.

Sensor 631 may include any of a variety of sensors. Sensor 631 may include at least one of: a liquid quantity sensor to sense a quantity of liquid passing through a system, a liquid flow sensor to sense the flow of a liquid through a system, a motion sensor to sense motion of tracking device 102, 202, 302, 502, an orientation sensor to sense the orientation of tracking device 102, 202, 302, 502, an accelerometer (or other binary position sensor) to sense movement and/or orientation of tracking device 102, 202, 302, 502, a gyroscope to sense movement and/or orientation of tracking device 102, 202, 302, 502, a global positioning system sensor to sense movement and/or orientation of tracking device 102, 202, 302, 502, a magnetometer to sense movement and/or orientation of tracking device 102, 202, 302, 502 relative to a magnetic field, a force sensor to sense force applied to tracking device 102, 202, 302, 502, a pressure sensor to sense pressure of a fluid passing through a system and/or pressure applied to tracking device 102, 202, 302, 502, a light sensor to sense movement of tracking device 102, 202, 302, 502, a radio frequency identification sensor to sense proximity of a user and/or identify a particular user, a temperature sensor to sense the ambient temperature in the area of tracking device 102, 202, 302, 502 and/or the temperature of a fluid passing through a system, a microphone to sense fluid mass and/or fluid flow, and a camera to visually recognize the position of handle 105, 405.

Sensor 631 may be calibrated for each application of tracking device 102, 202, 302, 502. Sensor 631 may, for example, sense the tipping of handle 105 and thus opening of valve 106, 406. A user may install sensor in a product tracking assembly 100, 400, open valve 106, 406, and dispense a known quantity of fluid into a container of a known volume. Sensor 631 may sense the amount of time during which handle 105 is tipped and thus the amount of time during which valve 106, 406 is opened. A user may calculate the volume of fluid dispensed during that amount of time, divide that volume by the amount of time recorded, and obtain a volume flow rate. This volume flow rate may be input into tracking device 102, 202, 302, 502 via an input element described herein, such that tracking device 102, 202, 302, 502 and sensor 631 is calibrated to the specific volume flow rate associated with that product tracking assembly 100, 400. Alternatively, a user may simply input the volume of fluid dispensed during the sensed time interval, and tracking device 102, 202, 302, 502 may perform the necessary calculation to determine the volume flow rate associated with that product tracking assembly 100, 400.

Product tracking assembly 100, 400 may experience inconsistency in the volume flow rate of dispensing of a product over time. For example, volume flow rate may change as product within the product storage container is diminished. As a result, tracking device 102, 202, 302, 502 and/or remote device 775 may apply a known curve to estimation of volume of product dispensed to account for this change, and may adjust recorded dispensed product volumes accordingly.

Product tracking assembly 100, 400 may experience inconsistency in the volume flow rate of dispensing of a product due to inconsistent opening of valve 106, 406. That is, where a user, such as a bartender, does not open valve 106, 406 completely, fluid may not be dispensed at the calibrated volume flow rate. Sensor 631 may sense how far valve 106, 406 is opened, for example by how far handle 105, 405 is actuated during product dispensing. Tracking device 102, 202, 302, 502 and/or remote device 775 may sense failure to open valve 106, 406 completely, and may at least one of: alert the user (e.g., bartender) to open valve 106, 406 completely, and adjust the calculated product dispensed volume to account for failure to open valve 106, 406 completely.

Tracking device 102, 202, 302, 502 may integrate with a wireless temperature sensor located in a product storage area (e.g., a cooler) and alert a user if storage temperatures are not within a desired threshold. Tracking device 102, 202, 302, 502 may integrate with a wireless CO2 regulator sensor operatively connected to a CO2 supply connected to product tracking assembly 100, 400, and alert a user if CO2 pressures/supplies are not within a desired threshold. Tracking device 102, 202, 302, 502 may integrate with a wireless gas regulator sensor operatively connected to a gas supply connected to product tracking assembly 100, 400, and alert a user if gas pressures/supplies are not within a desired threshold. The gas may include any gas commonly used to pressurize a fluid to be dispensed, including for example, CO2, N2, O2, atmospheric air, and the like. Tracking device 102, 202, 302, 502 may integrate with a sensor including at least one of: a temperature sensor configured to measure a temperature of a product in product storage, a temperature sensor configured to measure a temperature of a product in a product delivery system, and a gas regulator sensor configured to measure a pressure of a gas supply operatively connected to the product delivery system. In this manner, tracking device 102, 202, 302, 502 and/or remote device 775 may provide a user with a general “system health” analysis.

FIG. 7 illustrates an internal plan view of a remote device 775 for a system for tracking product inventory. Remote device 775 may include a smart phone 776. The description provided herein regarding smart phone 776 is for clarity, and is not intended to limit the description to any specific machine. Various machines can be utilized without departing from the scope of the embodiments described herein such as, for example, a mobile phone, a tablet computing device, a smart watch, a computer, a laptop computer, a desktop computer, or a specialized machine having communication capability.

Smart phone 776 may include one or more processors 777 for executing machine readable instructions to perform functions according to the methods described herein. As used herein, the term “processor” may mean any device capable of executing machine readable instructions. Accordingly, each processor may be a controller, an integrated circuit, a microchip, or any other device capable of implementing logic. Specific examples of the one or more processors 777 may include a touch screen controller, a baseband controller, a graphics processor, an application processor, an image processor, and the like.

Smart phone 776 may include a memory 778 communicatively coupled to the one or more processors 777 (generally depicted as double arrowed lines). As used herein, the phrase “communicatively coupled” may mean that components are capable of exchanging data signals with one another such as, for example, electrical signals via conductive medium, electromagnetic signals via air, optical signals via optical waveguides, quantum entanglement, and the like. Memory 778 described herein may be RAM, ROM, a flash memory, a hard drive, or any device capable of storing machine readable instructions. Accordingly, smart phone 776 may implement a mobile operating system as machine readable instructions stored on memory 778 and executed by the one or more processors 777. Specific examples of mobile operating systems include, but are not limited to, Android, iOS, Blackberry OS, Windows Phone, Symbian, and the like.

Additionally, the functions, modules, and processes described herein may be provided as machine readable instructions stored on memory 778 and executed by one or more processors 777. The machine readable instructions may be provided in any programming language of any generation (e.g., 1GL, 2GL, 3GL, 4GL, or 5GL) such as, e.g., machine language that may be directly executed by the processor, or assembly language, object-oriented programming (OOP), scripting languages, microcode, etc., that may be compiled or assembled into machine readable instructions and stored on a machine readable medium. Alternatively, the functions, modules, and processes described herein may be written in a hardware description language (HDL), such as logic implemented via either a field-programmable gate array (FPGA) configuration or an application-specific integrated circuit (ASIC), and their equivalents. Accordingly, the functions, modules, and processes described herein may be implemented in any conventional computer programming language, as pre-programmed hardware elements, or as a combination of hardware and software components.

Smart phone 776 may include a display 779 communicatively coupled to the one or more processors 777 for providing optical signals and conveying visual feedback to users of smart phone 776. In some embodiments, display 779 may be configured to selectively illuminate a plurality of pixels to provide the optical signals. Accordingly, display 779 may include light emitting diodes (LED or OLED), liquid crystal display (LCD), liquid crystal on silicon (LCOS), and the like. Additionally, display 779 may be configured to operate as a touch screen for accepting tactile input via visual controls. Accordingly, display 779 may include a touch detector such as, for example, a resistive sensor, capacitive sensor, and the like. The term “signal,” as used herein, may mean a quantum state or a waveform (e.g., electrical, optical, magnetic, or electromagnetic), such as DC, AC, sinusoidal-wave, triangular-wave, square-wave, and the like, capable of traveling through a medium. The term “optical” may refer to various wavelengths of the electromagnetic spectrum such as, but not limited to, wavelengths in the ultraviolet (UV), infrared (IR), and visible portions of the electromagnetic spectrum.

Referring still to FIG. 7, smart phone 776 may include a network interface hardware 780 communicatively coupled to the one or more processors 777 for communicatively coupling smart phone 776 to another device via a network such as, for example, a wide area network, a local area network, personal area network, a global positioning system and combinations thereof. Accordingly, network interface hardware 780 may be configured to communicate, i.e., send and/or receive data signals via any wired or wireless communication protocol. For example, network interface hardware 780 may include an antenna, a modem, a LAN port, a wireless fidelity (Wi-Fi) card, a WiMax card, a near-field communication hardware, a satellite communication hardware, and the like. Accordingly, smart phone 776 may be communicatively coupled to a network via wires, via a wide area network, via a local area network, via a personal area network, via a satellite network, and the like. Suitable local area networks may include wired Ethernet and/or wireless technologies such as, for example, Wi-Fi. Suitable personal area networks may include wireless technologies such as, for example, IrDA, BLUETOOTH, Wireless USB, Z-WAVE, ZIGBEE, and the like. Alternatively or additionally, suitable personal area networks may include wired computer buses such as, for example, USB and FIREWIRE. Thus, any components of smart phone 776 may utilize one or more network components to communicate signals via the Internet or the World Wide Web.

Smart phone 776 may include a radio frequency hardware (RF hardware) 781 communicatively coupled to the one or more processors 777 for communicatively coupling smart phone 776 with a cellular network. Suitable cellular networks include, but are not limited to, technologies such as LTE, WiMAX, UMTS, CDMA, and GSM. In some embodiments, RF hardware 781 may include components suitable for communicating voice information and data signals such as, for example, modems, attenuators, antennas, antenna switches, amplifiers, receivers, transceivers, or combinations thereof. Accordingly, smart phone 776 described herein may utilize a cellular network to communicate signals over the Internet or the World Wide Web.

RF hardware 781 may include a receiver configured to receive a sensed condition from wireless communication device 632. RF hardware 781 may include a receiver configured to receive a sensed condition from a network. RF hardware 781 may include a receiver configured to receive a sensed condition from wireless communication device 632 via a network intermediary. The network may be a wireless network. RF hardware 781 may include a receiver configured to receive a sensed condition from wireless communication device 632 and from a network.

Memory 778 may be configured to store a sensed condition received by RF hardware 781. Display 779 may display the sensed condition received by RF hardware 781.

Smart phone 776 may include a Global Positioning System (GPS) receiver 782 communicatively coupled to the one or more processors 777. GPS receiver 782 may be configured to provide signals indicative of the location of smart phone 776. Specifically, GPS receiver 782 may receive signals encoded with location data, time data or both from a plurality of GPS satellites, when GPS receiver 782 has a substantially unobstructed line of sight to the GPS satellites.

Referring still to FIG. 7, smart phone 776 may include an optical sensor 783 communicatively coupled to the one or more processors 777 for detecting optical signals and encoding the detected signals into an image or collection of images (e.g., video). In some embodiments, optical sensor 783 may include semiconductor charge-coupled devices (CCD), complementary metal-oxide-semiconductors (CMOS), N-type metal-oxide-semiconductors (NMOS), and the like. Accordingly, one or more images may be captured by optical sensor 783 and stored in memory 778.

Smart phone 776 may include one or more input device 784 for sensing input and encoding the input into a signal indicative of the input. Suitable examples of input device 784 may include a microphone, a button, a knob, a switch, a resistive sensor, a capacitive sensor, a microphone, a keyboard, and the like. Alternatively or additionally, display 779 may be configured to receive user input and operate as input device 784. Alternatively or additionally, display 779 may be a portion of a graphical user interface configured to receive user input. In addition to the aforementioned components, smart phone 776 may include one or more additional components communicatively coupled to the one or more processors 777 without departing from the scope of the embodiments described herein. Suitable additional components include, but are not limited to, speakers, accessory lights (e.g., LED), motion sensors, and the like.

Alternatively or additionally, remote device 775 includes a graphical user interface comprising a series of user controls such as input fields, sliders, radio buttons, and the like to allow a user to program and/or configure the system. The graphical user interface may allow a user to interact with the system. The graphical user interface may be configured to permit a user to control at least one of tracking device 102, 202, 302, 502 and remote device 775. Input device 784 may be configured to allow a user to control the graphical user interface.

Alternatively or additionally, remote device 775 includes an audio user interface comprising voice recognition software configured to receive a user's voice commands and allow a user to interact with the system. The audio user interface may be configured to permit a user to control at least one of tracking device 102, 202, 302, 502 and remote device 775. Input device 784 may be configured to allow a user to control the audio user interface. In addition to, or as an alternative to, display 779, remote device 775 may provide a user with data regarding product conditions, product inventory, and the like, via audio output.

Remote device 775 may be configured to authenticate and communicate with at least one of: a social media account, a product procurement account, an electronic mail account, an Internet service provider account, a local area network user account, and a cellular voice and/or data account. For example, information about the high rate of distribution of a specific product may be shared via a social media account, so as to convey to subscribers of that social media account the popularity of that product. Additionally, for example, information regarding product consumption and product remaining in inventory may be transmitted to a product procurement account to request that a supplier provide additional product for inventory or replacement. For example, information regarding product consumption and/or product remaining may be transmitted via an, or to an, electronic mail account to notify a user regarding the consumption rate of the product, remaining product, or any additional properties of the product (e.g., temperature) that may be useful to the user and described herein. Additionally, for example, information about the product may be distributed to a cellular voice account and/or cellular data account to notify a user regarding properties of the product, trends, and the like.

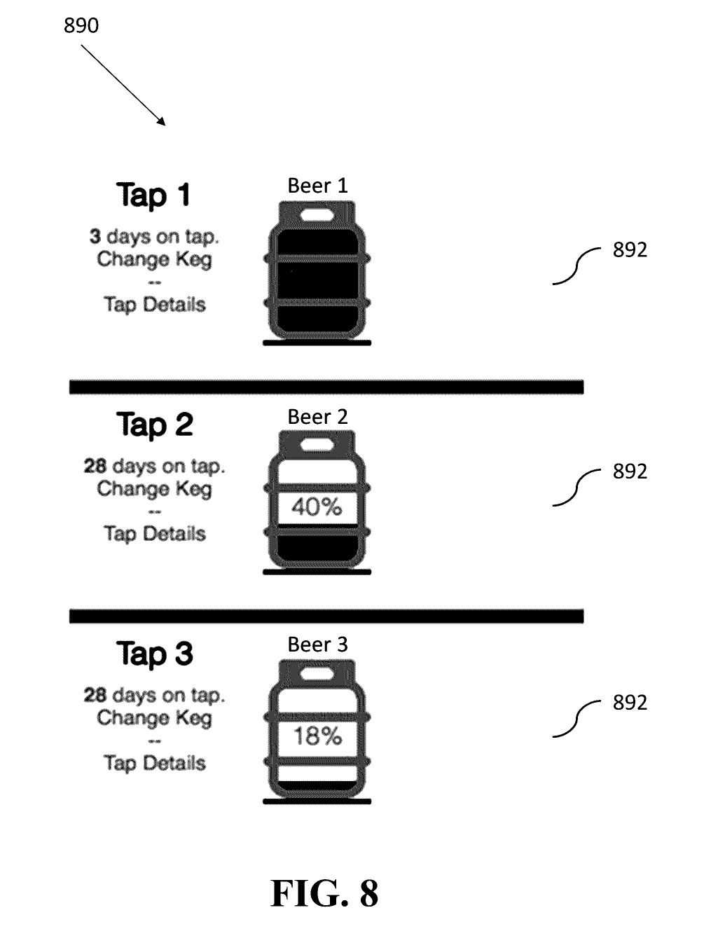

FIG. 8 illustrates a sample display 890 of product information. Display 890 may illustrate details 892 about individual product tracking assembly 100, 400, including values of remaining product (e.g., percentage or volumes), the amount of time that a particular product has been available for dispensing (e.g., number of days), recommended actions (e.g., change keg out due to low volume or time that the particular product has been available for dispensing, where product is perishable, and any desired details related to that particular product dispenser (e.g., tap details).

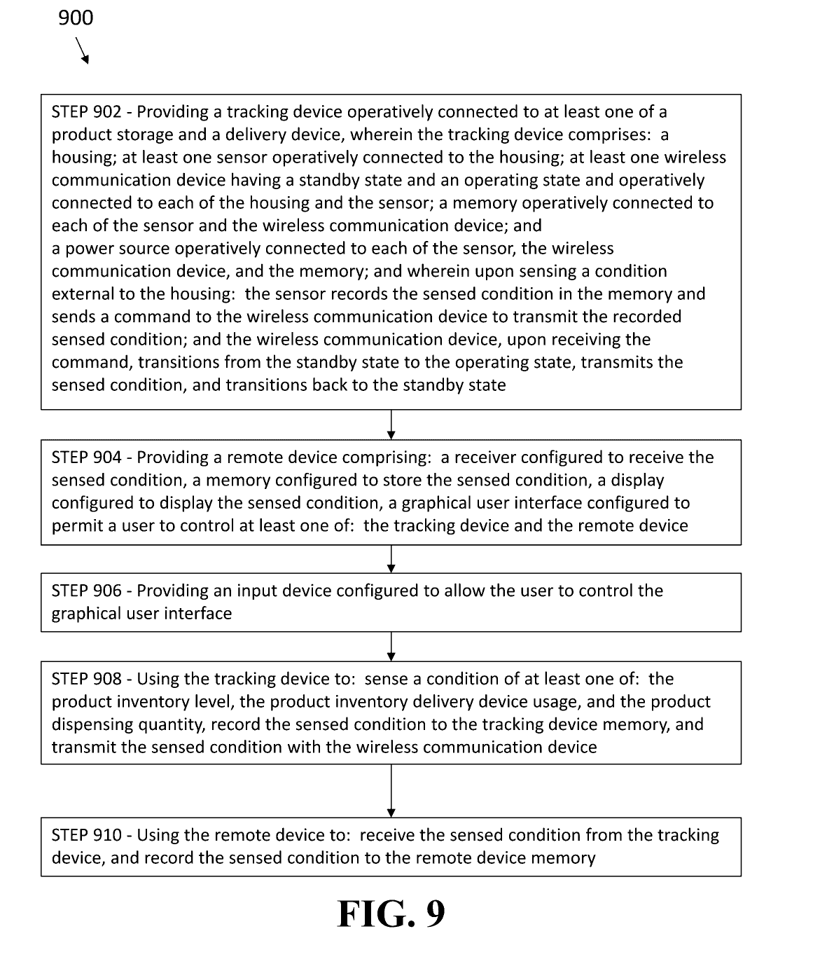

FIG. 9 illustrates a method 900 for using a tracking device.

Method 900 may include steps of: providing a tracking device operatively connected to at least one of a product storage and a delivery system, wherein the tracking device comprises: a housing; at least one sensor operatively connected to the housing; at least one wireless communication device having a standby state and an operating state and operatively connected to each of the housing and the sensor; a memory operatively connected to each of the sensor and the wireless communication device; and a power source operatively connected to each of the sensor, the wireless communication device, and the memory; and wherein upon sensing a condition external to the housing: the sensor records the sensed condition in the memory and sends a command to the wireless communication device to transmit the recorded sensed condition; and the wireless communication device, upon receiving the command, transitions from the standby state to the operating state, transmits the sensed condition, and transitions back to the standby state (step 902).

Method 900 may further include: providing a remote device comprising: a receiver configured to receive the sensed condition, a memory configured to store the sensed condition, a display configured to display the sensed condition, a graphical user interface configured to permit a user to control at least one of: the tracking device and the remote device (step 904).

The method further includes: providing an input device configured to allow the user to control the graphical user interface (step 906).

Method 900 may further include: using the tracking device to: sense a condition of at least one of: a product inventory level, a product inventory delivery system consumption, and a product dispensing quantity, record the sensed condition to the tracking device memory, and transmit the sensed condition with the wireless communication device (step 908).

Method 900 may further include: using the remote device to: receive the sensed condition from the tracking device, and record the sensed condition to the remote device memory (step 910).

Additionally, method 900 may include: the standby state of the tracking device consuming a sufficient quantity of power from the power source for the communication device to receive and interpret the command from the sensor, but consuming an insufficient quantity of power from the power source than is needed for the communication device to communicate wirelessly. The method may further include; the operating state of the tracking device consuming a sufficient quantity of power from the power source for the communication device to communicate wirelessly.

Additionally, the housing of the tracking device may be constructed from a heat conductive metal or alloy and is operatively connected to a product inventory storage and/or delivery system. The housing may be operatively connected by at least one of: an adhesive, a clamp, a hook and loop faster, a threaded screw, a threaded recess, a snap fitting, a magnet, a hook, a ring, a string, a wire, and a rope. At least one sensor of the tracking device may include at least one of: a liquid quantity sensor, a liquid flow sensor, a motion sensor, an orientation sensor, an accelerometer, a gyroscope, a global positioning system sensor, a magnetometer, a force sensor, a pressure sensor, a light sensor, a radio frequency identification sensor, a temperature sensor, a microphone, and a camera. The at least one wireless communication device of the tracking device may communicate by at least one radio frequency and includes at least one of: a transmitter, a receiver, a transceiver, and an antenna. The memory of the tracking device may include a nonvolatile semiconductor memory. The power source of the tracking device may include at least one electric battery.

Additionally, the remote device may be at least one of: a smart phone, a tablet computing device, a smart watch, and a computer. The remote device may be configured to both authenticate and communicate with at least one of: a social media account, a product procurement account, an electronic mail account, an Internet service provider account, a local area network user account, a cellular voice and/or cellular data account, and a remote database.

Additionally, method 900 may include: posting a message to the social media account; transmitting an order for an additional product to the product procurement account; and/or transmitting a message to at least one of: the electronic mail account and the cellular voice and/or cellular data account. The method may include recording the sensed condition to the remote database.

Tracking device 102, 202, 302, 502 may communicate with remote device 775 and display any of a variety of outputs as desired. For example, remote device 775 may display the amount of volume remaining in a specific supply of product by knowing the amount of time that fluid was dispensed and the volume flow rate of the specific product tracking assembly 100, 400 from which the fluid was dispensed. A user may be provided with an estimated date of depletion of product so as to facilitate ordering of replacement product in a well-timed manner. In another example, remote device 775 may display a graph showing the popularity of a specific product over a given time period, for example by displaying the volume of product dispensed each day within the given time period. Remote device 775 may display trends associated with the dispensing of a specific product over a given period of time.

In one embodiment, a representative of a supplier, a manager, or otherwise a user of the system described herein may log into software (e.g., SaaS software), review the current inventory and/or events triggered by sensor 631, and set rules for alerts based upon depletion rates of product inventory, or other events. These alerts can be communicated as described above, including via a cellular data account, and transmitted to any of the accounts described above, including a cellular phone. Additionally, alerts can be pop up push alerts that are part of a smart phone, emails, voice alerts transmitted to a cellular phone, and the like. Additionally, alerts may trigger flashing lights in product tracking assembly 100, 400 (e.g., within tracking device 102, 202, 302, 502), flashing lights in point of sale terminals/cash registers, and the like.

Use of tracking device 102, 202, 302, 502 on product tracking assembly 100, 400 may be used to deter loss associated with users, such as bartenders, not recording volumes of product dispensed within point of sale terminals/cash registers. Use of tracking device 102, 202, 302, 502 on product tracking assembly 100, 400 may be used to train users, such as bartenders, on the proper quantity of product to dispense and/or the proper method of dispensing a product.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in the art. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A device for tracking product inventory, comprising:
a housing;
at least one sensor operatively connected to the housing;
at least one wireless communication device having a standby state and an operating state and operatively connected to each of the housing and the sensor;
a memory operatively connected to each of the sensor and the wireless communication device; and
a power source operatively connected to each of the sensor, the wireless communication device, and the memory; and
wherein upon sensing a condition external to the housing:
the sensor records the sensed condition in the memory and sends a command to the wireless communication device to transmit the recorded sensed condition; and
the wireless communication device, upon receiving the command, transitions from the standby state to the operating state, transmits the sensed condition, and transitions back to the standby state.

2. The device of claim 1, wherein the standby state consumes a sufficient quantity of power from the power source for the communication device to receive and interpret the command from the sensor, but consumes an insufficient quantity of power from the power source than is needed for the communication device to communicate wirelessly, and
wherein the operating state consumes a sufficient quantity of power from the power source for the communication device to communicate wirelessly.

3. The device of claim 1, wherein the housing is constructed from a heat conductive metal or alloy and is operatively connected to at least one of a product inventory storage and a delivery system, wherein the housing is operatively connected by at least one of: an adhesive, a clamp, a hook and loop faster, a threaded screw, a threaded recess, a snap fitting, a magnet, a hook, a ring, a string, a wire, and a rope.

4. The device of claim 1, wherein the at least one sensor includes at least one of: a liquid quantity sensor, a liquid flow sensor, a motion sensor, an orientation sensor, an accelerometer, a gyroscope, a global positioning system sensor, a magnetometer, a force sensor, a pressure sensor, a light sensor, a radio frequency identification sensor, a temperature sensor, a microphone, and a camera.

5. The device of claim 1, wherein the at least one wireless communication device communicates by at least one radio frequency and includes at least one of: a transmitter, a receiver, a transceiver, and an antenna.

6. The device of claim 1, wherein the memory includes a nonvolatile semiconductor memory.

7. The device of claim 1, wherein the power source includes at least one electric battery.

8. A system for tracking product inventory, comprising:
a tracking device comprising:
a housing;
at least one sensor operatively connected to the housing;
at least one wireless communication device having a standby state and an operating state and operatively connected to each of the housing and the sensor;
a memory operatively connected to each of the sensor and the wireless communication device; and
a power source operatively connected to each of the sensor, the wireless communication device, and the memory; and
wherein upon sensing a condition external to the housing:
the sensor records the sensed condition in the memory and sends a command to the wireless communication device to transmit the recorded sensed condition; and
the wireless communication device, upon receiving the command, transitions from the standby state to the operating state, transmits the sensed condition, and transitions back to the standby state; and
a remote device comprising:
a receiver configured to receive the sensed condition,
a memory configured to store the sensed condition,
a display configured to display the sensed condition,
a graphical user interface configured to permit a user to control at least one of:
the tracking device and the remote device, and
an input device configured to allow the user to control the graphical user interface.

9. The system of claim 8, wherein the standby state of the tracking device consumes a sufficient quantity of power from the power source for the communication device to receive and interpret the command from the sensor, but consumes an insufficient quantity of power from the power source than is needed for the communication device to communicate wirelessly, and
wherein the operating state of the tracking device consumes a sufficient quantity of power from the power source for the communication device to communicate wirelessly.

10. The system of claim 8, wherein the housing of the tracking device is constructed from a heat conductive metal or alloy and is operatively connected to at least one of a product inventory storage and a product delivery system, wherein the housing is operatively connected by at least one of: an adhesive, a clamp, a hook and loop faster, a threaded screw, a threaded recess, a snap fitting, a magnet, a hook, a ring, a string, a wire, and a rope.

11. The system of claim 8, wherein the at least one sensor of the tracking device includes at least one of: a liquid quantity sensor, a liquid flow sensor, a motion sensor, an orientation sensor, an accelerometer, a gyroscope, a global positioning system sensor, a magnetometer, a force sensor, a pressure sensor, a light sensor, a radio frequency identification sensor, a temperature sensor, a microphone, and a camera.

12. The system of claim 8, wherein the at least one wireless communication device of the tracking device communicates by at least one radio frequency and includes at least one of: a transmitter, a receiver, a transceiver, and an antenna.

13. The system of claim 8, wherein the memory of the tracking device includes a nonvolatile semiconductor memory, and
wherein the power source of the tracking device includes at least one electric battery.

14. The system of claim 8, wherein the remote device is at least one of: a smart phone, a tablet computing device, a smart watch, and a computer.

15. The system of claim 8, wherein the remote device is configured to both authenticate and communicate with at least one of: a social media account, a product procurement account, an electronic mail account, an Internet service provider account, a local area network user account, a cellular voice account, and a cellular data account.

16. A method for tracking product inventory, comprising:
providing a tracking device operatively connected to at least one of a product storage and a delivery system, wherein the tracking device comprises:
a housing;
at least one sensor operatively connected to the housing;
at least one wireless communication device having a standby state and an operating state and operatively connected to each of the housing and the sensor;
a memory operatively connected to each of the sensor and the wireless communication device; and
a power source operatively connected to each of the sensor, the wireless communication device, and the memory; and
wherein upon sensing a condition external to the housing:
the sensor records the sensed condition in the memory and sends a command to the wireless communication device to transmit the recorded sensed condition; and
the wireless communication device, upon receiving the command, transitions from the standby state to the operating state, transmits the sensed condition, and transitions back to the standby state;
providing a remote device comprising:
a receiver configured to receive the sensed condition,
a memory configured to store the sensed condition,
a display configured to display the sensed condition,
a graphical user interface configured to permit a user to control at least one of:
the tracking device and the remote device, and
providing an input device configured to allow the user to control the graphical user interface; and
wherein the method comprises:
using the tracking device to:
sense a condition of at least one of: a product inventory level, a product inventory delivery system consumption, and a product dispensing quantity,
record the sensed condition to the tracking device memory, and
transmit the sensed condition with the wireless communication device;
and
using the remote device to:
receive the sensed condition from the tracking device, and
record the sensed condition to the remote device memory.

17. The method of claim 16, wherein the standby state of the tracking device consumes a sufficient quantity of power from the power source for the communication device to receive and interpret the command from the sensor, but consumes an insufficient quantity of power from the power source than is needed for the communication device to communicate wirelessly, and
wherein the operating state of the tracking device consumes a sufficient quantity of power from the power source for the communication device to communicate wirelessly.

18. The method of claim 16, wherein:
the housing of the tracking device is constructed from a heat conductive metal or alloy and is operatively connected to at least one of a product inventory storage and a product delivery system, and
wherein the housing is operatively connected by at least one of: an adhesive, a clamp, a hook and loop faster, a threaded screw, a threaded recess, a snap fitting, a magnet, a hook, a ring, a string, a wire, and a rope;
wherein the at least one sensor of the tracking device includes at least one of: a liquid quantity sensor, a liquid flow sensor, a motion sensor, an orientation sensor, an accelerometer, a gyroscope, a global positioning system sensor, a magnetometer, a force sensor, a pressure sensor, a light sensor, a radio frequency identification sensor, a temperature sensor, a microphone, and a camera;
wherein the at least one wireless communication device of the tracking device communicates by at least one radio frequency and includes at least one of: a transmitter, a receiver, a transceiver, and an antenna; and
wherein the memory of the tracking device includes a nonvolatile semiconductor memory, and
wherein the power source of the tracking device includes at least one electric battery.

19. The method of claim 16, wherein the remote device is at least one of: a smart phone, a tablet computing device, a smart watch, and a computer; and
wherein the remote device is configured to both authenticate and communicate with at least one of: a social media account, a product procurement account, an electronic mail account, an Internet service provider account, a local area network user account, a cellular voice account, a cellular data account, and a remote database.

20. The method of claim 19, further comprising at least one of the following steps:
posting a message to the social media account;
transmitting an order for an additional product to the product procurement account;
transmitting a message to at least one of: the electronic mail account and the cellular voice account, and the cellular data account; and
recording the sensed condition to the remote database.

21. The method of claim 16, wherein the at least one sensor of the tracking device includes at least one of: a temperature sensor configured to measure a temperature of a product in the product storage, a temperature sensor configured to measure a temperature of a product in the product delivery system, and a gas regulator sensor configured to measure a pressure of a gas supply operatively connected to the product delivery system.
